(19) United States
(12) Patent Application Publication
(10) Pub. No.: US 2008/0205983 A1
(43) Pub. Date: Aug. 28, 2008

(54) Slot cutting apparatus

(75) Inventor: Terrence L. Kraemer, St. Cloud, MN (US)

Correspondence Address: MERCHANT & GOULD PC, P.O. BOX 2903, MINNEAPOLIS, MN, 55402-0903, US

(73) Assignee: Diamond Surface, Inc., Maple Grove, MN (US)

(21) Appl. No.: 11/709,909

(22) Filed: Feb. 22, 2007

(51) Int. Cl. E01C 23/02; B62D 11/02; E21C 25/00

(52) U.S. Cl. 404/87; 180/6.2; 299/39.4

(57) ABSTRACT

A system for cutting slots in pavement has a first slot cutting vehicle with a cutting assembly having several pairs of rotating blades mounted to the first vehicle and vertically adjustable relative to the vehicle. A lift system moves the first vehicle between a first position wherein the lift is not engaging the ground and a raised position wherein the lift engages the ground and supports the vehicle. A slider assembly uses a hydraulic ram to move the vehicle horizontally on rails relative to the lift when the vehicle is at the raised position. In operation, the vehicle is lifted and the cutting assembly lowered so the blades engage the pavement. The vehicle slides back and forth so the blades cut opposed pairs of sides of slots. Material between each slot is removed with a second cutting vehicle having a cutting assembly with radial blades spaced the same distance apart as the blade pairs of the first vehicle. The blades of the second cutting vehicle have a width equal to the distance between the pairs of blades on the first cutting vehicle to remove material between the cut sides of the slots.

### BACKGROUND OF THE INVENTION

1. Field of the Invention

The present invention is directed to a method and apparatus for cutting slots in pavement and in particular to a method and apparatus for cutting slots for reinforcement devices that are inserted to reinforce pavement joints.

2. Description of the Prior Art

Roads and other pavement surfaces are conventionally constructed with joints formed for expansion and contraction. To strengthen such joints, reinforcement dowels are inserted beneath the surface of the pavement and spanning the joint to anchor both sections of the pavement. These reinforcement assemblies are located at spaced intervals extending across the width of the road the normal tire travel paths. These locations are commonly known as load transfer restoration locations. Three dowels are typically spaced at intervals along the joint at each tire travel path. The reinforcing structure typically includes a slot formed in the pavement with a reinforcing bar held in a support structure commonly referred to as a “chair” across the joint and supporting the reinforcing dowel bar spaced up off the bottom of the slot. The reinforcing bar and chair are covered with pavement material and other filler so that the pavement surface is smooth and the joint is straight and smooth.

The performance of the reinforcement structure is improved if the chair is closely fit within the slot. Moreover, the performance of the reinforcing structure is improved if the bar is maintained at a position substantially parallel to the surface of the road. The bar should also be positioned so that it extends perpendicular to the joint for optimal performance.

It can be appreciated that milling and sawing pavement is a difficult and expensive operation. Blades can become quickly worn and substantial power is required for such operations. Devices to mill reinforcement slots for placing dowels are well known. The technique for placing new bars is similar to the method for replacing failed or deteriorating reinforcement structures. Milling such wide slots is especially difficult due to the power needed. Moreover, as the amount of material and depth to which the slot must be milled is large, the blades of the grinder wear so quickly that they must be replaced typically after only three or four slots have been milled. Such procedures are inefficient and are time and cost prohibitive.

Other techniques have been developed wherein sides of the slots are sawed and the material to be removed between the slots is taken out manually with jackhammers. An example of a saw for the cutting sides of such slots is disclosed in U.S. Pat. No. 5,492,431. Further improvements and a superior method have been shown in U.S. Pat. No. 7,073,975 to Kraemer. Although the Kraemer patent shows a method and system that provides for reliably cutting sides of slots with superior performance, further improvements are possible for finishing the slots installing the reinforcement structures.

Moreover, due to the depth and width of the slot, a first portion of the slot is removed with a jackhammer of a first width, typically a 35 pound jackhammer. This size of jackhammer limits the amount of material that may be removed with precision and leaves a bottommost portion of material to be removed, typically about ½ inch of concrete. This additional ½ of concrete must be removed with a more precise, narrower jackhammer, typically a 15 pound jackhammer. The use of jackhammers does not provide a consistent depth or smooth sides that provide superior performance for a reinforcing joint. Moreover, the use of such jackhammers typically involves 6-8 manual laborers for operating the tow sizes of jackhammers. Such an operation is time consuming and involves high manual labor costs.

It can be seen then that a new and improved system and method for making slots for pavement joint reinforcing systems is needed. Such a system and method should provide for cutting a deeper portion for accepting chairs for reinforcement rods at a consistent depth. Moreover, the width within the specified tolerances and the walls and bottom are smooth so that the reinforcing bar is at a specified depth parallel to the road surface and transverse to the joint. Such a system and method should also eliminate the need for removing the deepest material with jackhammers and eliminate large crews required for operating two different sizes of jackhammers. The present invention addresses these as well as other problems associated with installing reinforcement systems for pavement joints.

### SUMMARY OF THE INVENTION

The present invention is directed to a system and method for cutting joint reinforcement recesses in pavement. The system includes a first cutting apparatus on a first vehicle for cutting sides of slots or recesses and a second cutting apparatus on a second cutting vehicle for removing material between the opposed cut sides of the recesses. The first vehicle is a large, heavy vehicle and includes a frame body and wheels driven by an engine. The engine provides power to various systems and a cab includes controls for the various vehicle systems and allows the operator a clear view of the cutting operation from one location. In one embodiment, the vehicle also includes a lift system to raise the vehicle for precise cutting providing back and forth movement along rails associated with the lift system.

The first slot cutting assembly has three sets of cutting blades mounted in parallel on the vehicle and can be vertically adjusted for making pavement cuts at varying depths. The first vehicle includes a lift system in one embodiment that lifts the entire vehicle frame and chassis off the ground so that locking the wheels is not necessary, as is done with some prior art systems. The lift system supports the vehicle on legs, which are not locked, but do not roll or slide, so there is no need to lock the cutter wheels. The lift system also supports the cutting system with rails extending along the direction of travel so that the vehicle slides back and forth on the rails when lifted. A hydraulic ram moves the cutter back and forth relative to the lift when making cuts.

The cutting operation for sawing sides of the recesses begins by raising the first cutting vehicle. When the vehicle is raised, the cutting assembly supported at the front of the vehicle is lowered to engage the pavement. The vehicle chassis then moves back and forth, rolling on the rails of the slider assembly. In other embodiments without rails, the cutting blades are moved to a position above the slot locations and then lowered. As the cutting blades are at a lowered position below the pavement surface, they cut sides for slots in the pavement across the pavement joint. The cutting assembly may be lowered to progressively deeper positions on successive cuts and may cut both forward and backward. Moreover, the travel distance of the rails can be preset to achieve a consistent slot length. When the sides of the slots are finished, material between the slots is removed with a second cutting vehicle to form a recess. Each of the recesses receives reinforcement systems and is later filled to provide the proper reinforcement to the joint. Problems that may occur with prior art devices due to slippage of a lock or other unintended movement are overcome with the first embodiment of the first cutting vehicle. In addition, the mass of the entire vehicle including the motor, frame and body is utilized rather than locking a frame and moving just a cutting carriage, as is done with some prior art devices.

When the sides of the slots have been formed, a second cutting vehicle removes remaining material between the slots. The second cutting vehicle is a skid steer loader in one embodiment with a cutting assembly supported on the pivoting arms of the skid steer loader. The cutting assembly mounts on a cutter frame to the arms and includes spaced apart radial blades having teeth spaced around the periphery of the rotary blades. The teeth extend radially outward and slightly laterally to make a cut that is the width of the slots so as to remove material formed between the opposed sides made with the first cutting vehicle. The teeth are preferably removable and replaceable on the blades so that the width of the cut may be varied and the teeth may be replaced when worn. The blades are mounted on a rotating arbor driven by a hydraulic motor in one embodiment. The arbor is supported by bearings in a convention manner.

The second cutting assembly also includes depth adjustment mechanisms that allow for presetting the depth to which the blades extend for making the cuts into the pavement. The blades are spaced apart at the same distance as the sides of the slots so that the blades align with the previously cut sides to mill the entire width of the recess. The cuts are made by simply lowering the blades to engage the pavement between the precut sides of the slots. The vehicle is moved back and forth and moved to a sufficient depth until material between the sides is removed and the slots have been formed to the proper depth. The present invention provides for making the precise cut to a predetermined depth providing for a bottom recess that is substantially parallel to the surface of the pavement for correct spacing of the pavement joint support systems including the dowel and the chairs. The blades widths and depth adjustment mechanisms ensure that the slots are made to a consistent depth and width for receiving the support assemblies known as chairs and properly positioning the chairs for optimal performance.

When the slots have been formed, the pavement reinforcement systems are placed in the slots including a dowel extending across the pavement joint and on the support chairs, which maintain the dowel off the bottom of the slot and extending across the joint. A cap may be placed on one or both ends of the dowel and other surface treatments may be applied to the dowel for maintaining the proper tension between the dowel and the surrounding material. The slots are then completely filled with material back to the surface of the pavement to form the reinforced pavement joints having a smooth roadway surface.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring to the drawings, wherein like reference letters and numerals indicate corresponding structure throughout the several views:

FIG. 1 is a side elevational view of a pavement reinforcing joint made in accordance with the principles of the present invention;

FIG. 2 is a side elevational view of the reinforcement joint shown in FIG. 1;

FIG. 3 is a top plan view of parallel cuts in the pavement and spanning the pavement joint shown in FIG. 1;

FIG. 4 is a side elevational view of a slot for the reinforcement joint shown in FIG. 1;

FIG. 5 is a side elevational view of a first cutting vehicle for making the cuts shown in FIG. 3;

FIG. 6 is a front elevational view of the first cutting vehicle shown in FIG. 5;

FIG. 7 is a perspective view of a second cutting vehicle for removing material in the slots;

FIG. 8 is a front elevational view of the cutting assembly for the second cutting vehicle shown in FIG. 7;

FIG. 9 is a side elevational view of the cutting assembly shown in FIG. 8;

FIG. 10 is a perspective view of a portion of a blade and teeth for the cutting assembly shown in FIG. 8.

### DETAILED DESCRIPTION OF THE PREFERRED EMBODIMENTS

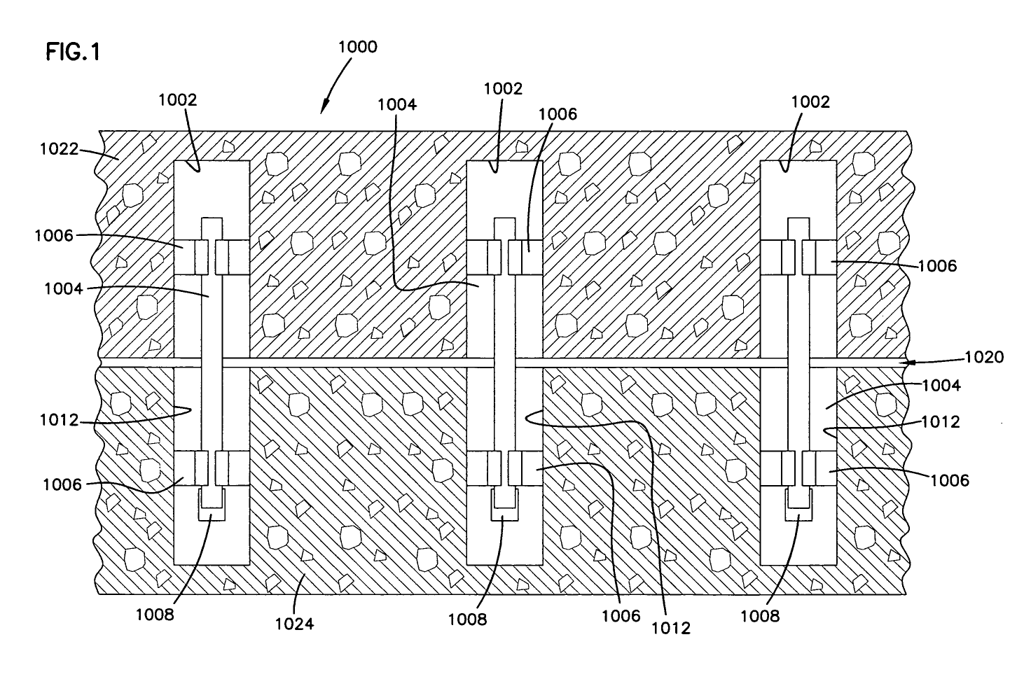

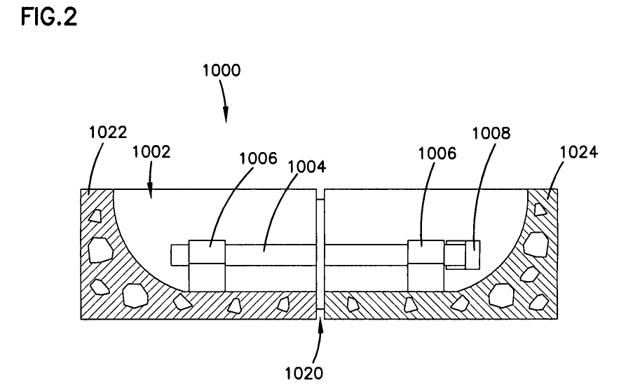

Referring now to the drawings and in particular to FIGS. 1-4, pavement reinforcing systems, generally designated 1000, are placed in recesses or slots 1002 as shown in FIG. 1, which are refilled to be level with the road surface. Such conventional reinforcing devices 1000 and techniques are well known in the art and utilize a dowel 1004 or other structure anchored at each end extending across a pavement joint 1020. The dowel 1004 is generally supported above the bottom of the recess 1002 by supports 1006, commonly known as chairs. Fill material, such as concrete, is deposited in the recess 1002 and flows around the dowel 1004 to securely anchor it to the pavement sections 1022 and 1024. The dowel may include an end cap 1008 on one or both ends of the dowel 1004. The reinforcement systems 1000 anchor and support the pavement 1022 and 1024 across the joint 1020 during expansion and contraction and strengthen the pavement 1022 and 1024 proximate the joint 1020.

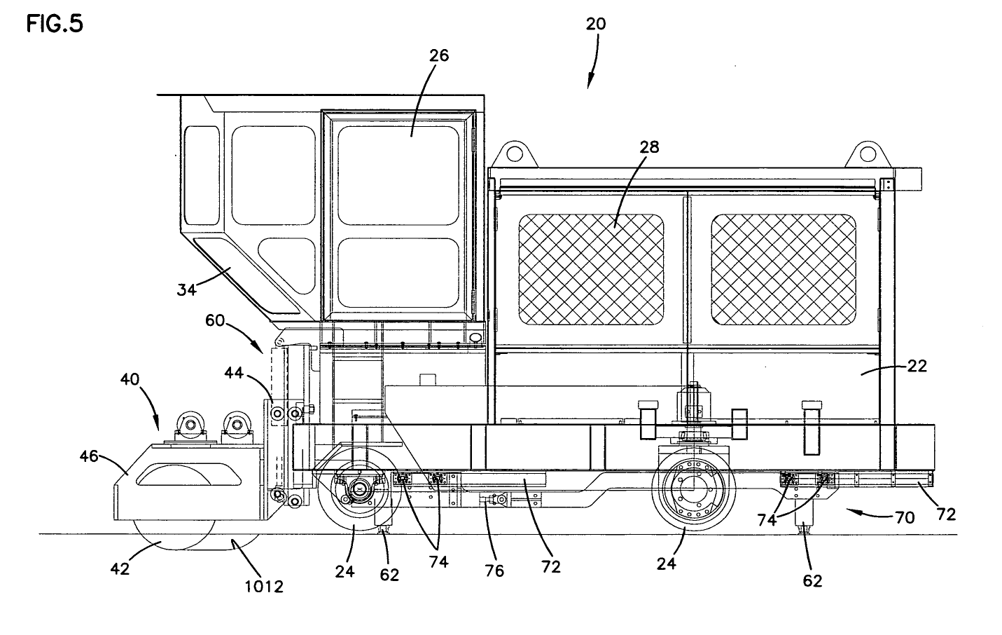

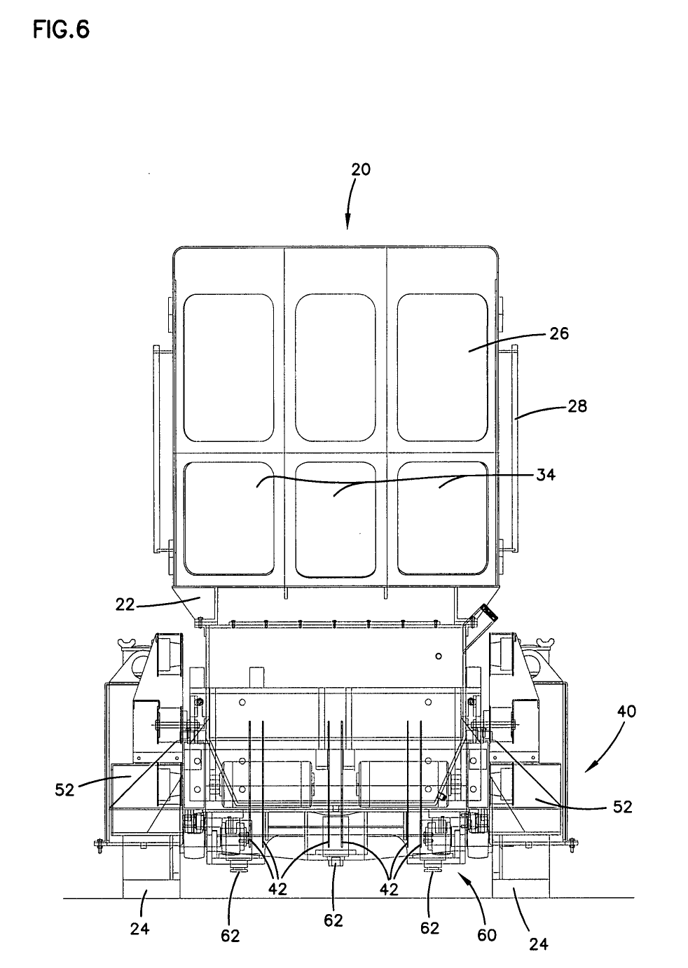

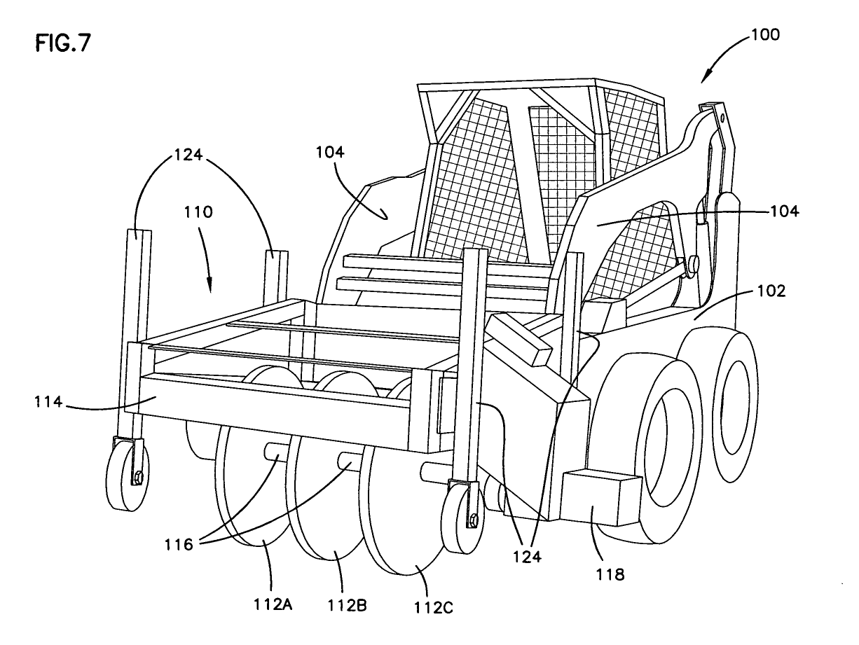

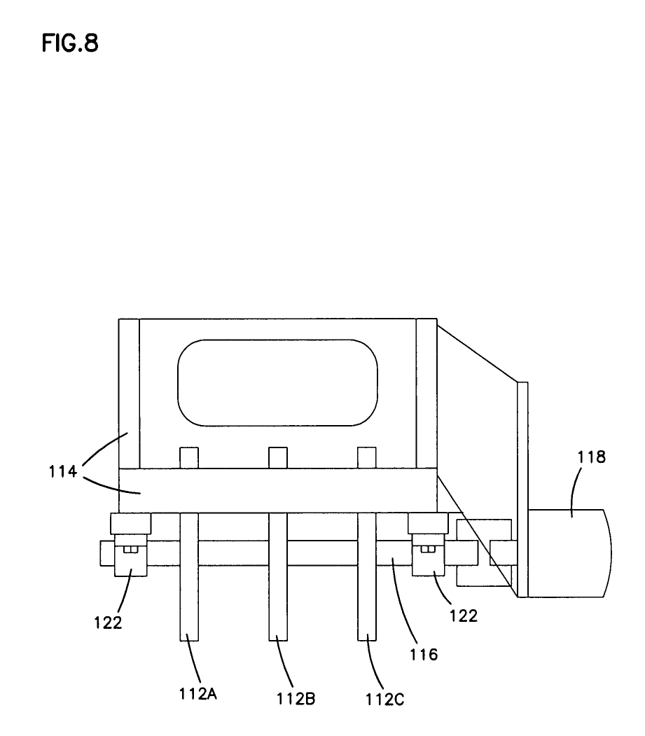

Referring to FIGS. 5-6, there is shown a first cutter vehicle, generally designated 20, for cutting sides of slots into pavement. More particularly, the cutter 20 is configured for cutting sides 1012 of slots 1002 at joints 1020. As explained hereinafter, material remaining between the cut sides 1012 is milled away in a separate operation to form recesses, or slots, that receive components to provide reinforcement to worn sections of the pavement. The sections of pavement with the highest wear are typically those areas below the normal path of travel for the tires of vehicles and particularly, heavier vehicles such as tractor-trailers. The sides of the recesses are made with the cutting vehicle 20 and material between the side cuts is removed with a dedicated cutting or milling type vehicle 100 shown in FIGS. 7-9 and described hereinafter.

The first cutting vehicle 20 includes a chassis with a frame and body 22 that moves back and forth while cutting sides 1012 of the slots 1002, as explained hereinafter. The cutter 20 includes wheels 24 for transport when the cutter 20 is not cutting. The cutter 20 also includes a cab 26 for an operator at the front portion of the cutting apparatus. The cab 26 contains the controls and viewing windows 34 including lower forward angled windows that allow an operator to view the cutting operation from the same location used for steering and operating other controls. An engine 28 provides power for moving the cutter 20, for powering a cutting assembly 40, and in the embodiment shown, for sliding the cutter 20 when lifted, as explained hereinafter. To the rear of the cab 26 is a slurry system 36. The slurry system 36 directs water to the cutting assembly and aids in cooling as well as containing dust and debris. Hydraulic lines have been omitted for clarity, but generally extend from the engine 28 to hydraulic motors and pistons of the cutting assembly 40, a lift assembly 60 and a slider assembly 70, as well as other hydraulic powered accessories of the cutter 20.

When being transported from location to location, the cutter 20 is supported on the wheels 24 to move the cutting assembly 40 and its blades 42. The cutter 20 may also cut in a conventional manner while driving on the wheels 24. However, in a typical cutting mode, the lift assembly 60 is actuated to lift the cutter 20 so that it is not supported on the wheels 24, as shown in FIG. 6. Hydraulic cylinders 62 serve as legs that are extended to lift the cutter 20, as shown in FIG. 6. When lifted, the cutter 20 does not require a lock and is simply supported on the stationary hydraulic lift legs 62. It can be appreciated that other configurations may also be utilized that do not require locking of the cutter 20 and provide a stable guide for the cutter 20 and the cutting assembly 40.

The cutting assembly 40 includes a plurality of pairs of diamond tipped pavement cutting blades 42 placed in a spaced apart parallel relationship. The blades 42 are arranged in pairs so that each pair of blades 42 cuts the opposed parallel sides of one reinforcement recess in the pavement at the same time. The material between the cuts is removed during a later operation with the cutting vehicle 100, as explained hereinafter. In addition, with several sets of blades 42, the recesses 1002 are properly aligned at the time of cutting and all of the slots at a load transfer restoration location are cut at the same time, rather than moving the cutting assembly 40 laterally or moving the entire cutter 20 over multiple times to cut multiple slots at a single joint 1020. The cutting assembly 40 includes a housing 46 and hydraulic motors 52 driving the blades 42 through belts, chains or other conventional drives. A depth adjustment 44 includes a hydraulic cylinder 54 to raise and lower the cutting assembly 40 and to adjust maximum depth during cutting.

The slider assembly 70 includes rails 72 and guide wheels 74 attached to the chassis 22. Hydraulic cylinders 76 extend and retract to move the chassis 22 back and forth relative to the rails 72. Although not locked, the rails 72 remain stationary while supported on the lift legs 62, providing a stable reference position for moving the entire chassis 22 back and forth and therefore, moving the blades 42 back and forth to make elongated cuts. The slider assembly 70 positions the cutter 20 so that the blades 42 are aligned and travel along the same path, thereby making repeatable cuts and allowing for making cuts at increasingly greater depths into the same slots. The present invention moves almost the entire cutter 20, rather than just a cutting carriage. In this manner, the blades 42 have the greater momentum of the mass of the cutter 20 behind the cuts, rather than just a carriage moving relative to the frame.

It can be appreciated that the lift assembly 60 and the slider assembly 70 provide for forward and back motion, but resist any lateral movement and lateral pressure due to a sloping pavement surface associated with the typical crown in the road, such as may occur when cutting methods are utilized wherein the entire vehicle is driven back and forth with conventional steering methods. However, for many applications, other cutting devices without a sliding assembly may be satisfactory in cutting the sides 1012.

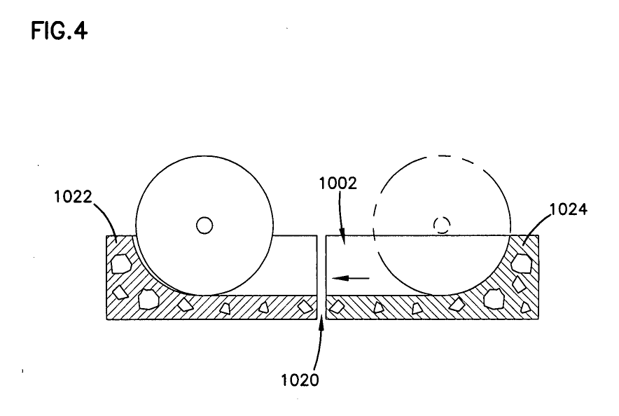

In operation, the cutter 20 is driven to a position so that the blade assembly 40 is preferably at the rear of a desired location for forming slots in the pavement 1024, as shown in FIG. 4. The blade assembly 40 is not yet lowered and remains at its raised travel position. The lift assembly legs 62 then extend so that the cutter chassis 22 is raised and the entire cutter 20 is supported on the lift assembly 60 and the extended hydraulic lift legs 62, as shown in FIG. 5. The cutter 20 is stationary and cannot roll from this position.

As shown in FIG. 5, cutting of the sides of the slots begins by lowering the cutting assembly 40 to engage the pavement 1022 and 1024. In the lowered position, the blades 42 are cutting into the pavement 1022 and 1024 and forming the sides 1012 of slots. It can be appreciated that the depth adjustment 44 must allow for applying sufficient downward pressure on the blades 42 to achieve satisfactory cutting action. The portion of the blades 42 engaging the pavement typically has a contact length less than the desired length of the slots. Therefore, the blades 42 must be moved back and forth to cut slots of the proper length, as shown in FIG. 4.

As shown in FIG. 6, the slider assembly 70 is actuated by extending the hydraulic cylinder 76 and pushing the chassis 22, and therefore the cutting assembly 40 and the blades 42, forward. This forward movement occurs while the blades 42 are cutting into the pavement. In this manner, the cuts for the slot sides 1012 are extended forward until reaching their predetermined length. It can be appreciated that the length of the cuts for the sides 1012 can be varied by controlling the extension and retraction of the hydraulic cylinder 76. In addition, the position of the front and back edges of the cuts for the sides 1012 may be varied slightly by controlling the position at which the cut begins through retraction or extension of the hydraulic cylinder 76. This additional adjustment decreases the precision needed by the operator when positioning the cutter 20 prior to cutting.

Depending upon cutting conditions, such as pavement characteristics, it may not be possible to cut the sides of the slots to the desired depth in one pass. Therefore, it may be necessary to cut at a first depth with a first pass, lower the cutting assembly 40 to a lower depth with the blades 42 cutting deeper and making an additional pass or additional passes. It can be appreciated that the length of the slot may be repeated at different depths with the present invention as the hydraulic cylinder 76 prevents coasting beyond the stop point. Moreover, the cab 26 has viewing windows 34 that allow the operator to clearly view the entire cutting operation. In addition, the cutter controls may be programmed to precisely repeat the cut at the same start and stop position. The controls also allow the operator to vary the length and depth of the cut and match the needs of the particular load restoration project. It can be appreciated that for some cutting conditions, cutting is only possible while moving the blades 42 forward and therefore, moving the entire cutter 20 forward. However, in other cutting operations, it may be possible to cut while moving forward as well as moving backward.

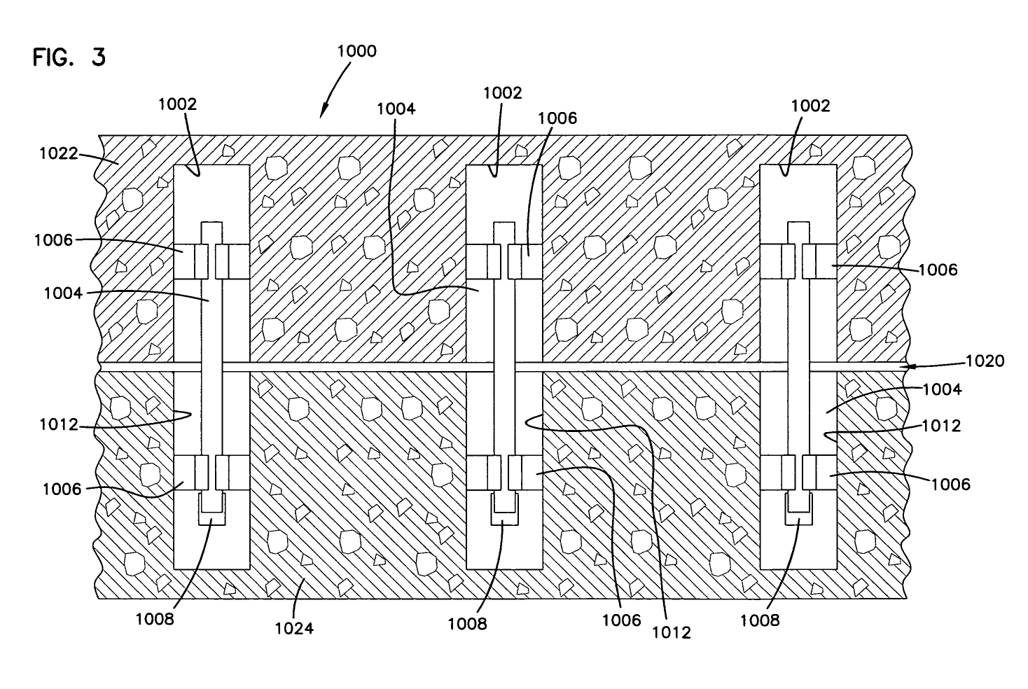

When cutting the sides 1012 of the slots 1002 with the cutter 20 is finished, the cutting assembly 40 is simply raised by retracting the depth control hydraulic cylinder 54. The lift assembly 60 is disengaged by retracting the lift legs 62 so that the cutter 20 is again supported on the wheels 24, as shown in FIG. 6. Opposed pairs of slot sides 1012 have been cut and properly spaced apart at this point, as shown in FIG. 3. The cutter 20 is then driven to the next joint 1020 in the road and slot cutting for the load restoration process is repeated. The cutter 20 provides for cutting at a fast rate with quick alignment. In addition, multiple pairs of slots are easily and precisely cut at the same time.

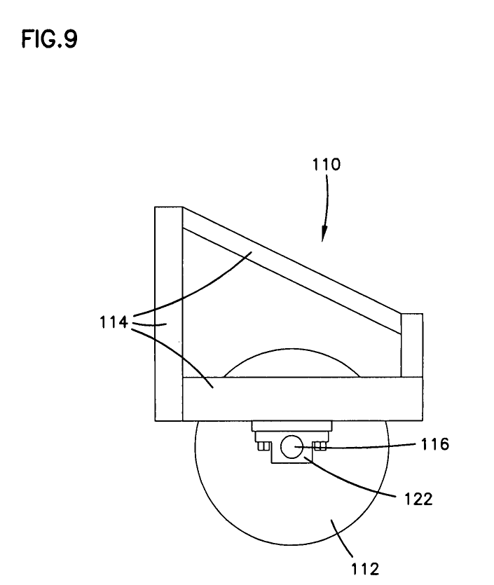

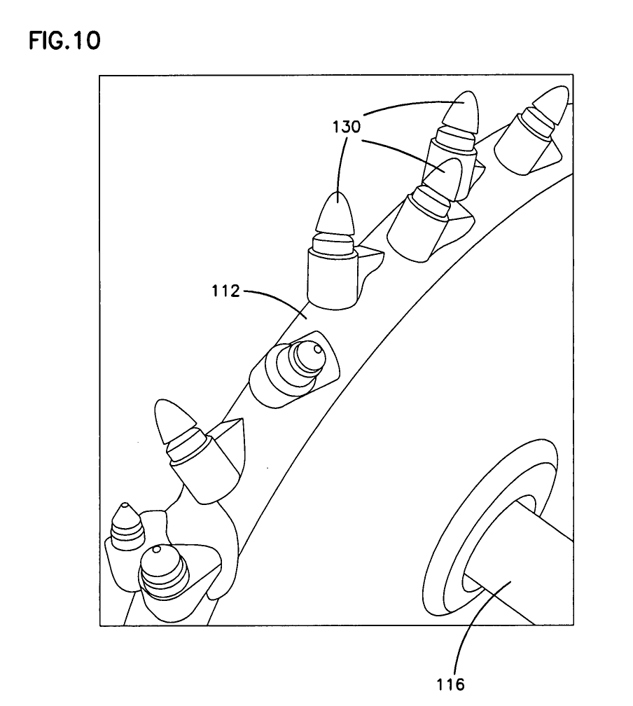

When the sides 1012 of the slots 1002 have been cut, material between each pair of side cuts is removed to form the recesses 1002. As shown in FIGS. 7-10, the second cutting vehicle 100 is generally configured as a skid steer loader and includes a chassis 102 and support arms 104 pivotally mounted to the chassis 102. Support arms 104 are configured as a conventional accessory for skid steer loaders and are well known. In the present invention, the cutting apparatus 100 includes a cutting assembly 110 mounted on the support arms 104. The cutting assembly 110 includes a frame 114 mounted to the support arms 104. In the embodiment shown, the cutting assembly 110 has three spaced apart disc type radial blades 112. The cutting assembly 110 includes three spaced apart blades 112A, 112B and 112C. It can be appreciated that the centerlines of the blade 112A, 112B and 112C are preferably spaced apart the same distance as the centerlines of the blade pairs of the first cutting vehicle 20. In this manner, when the sides 1012 of the slot have been cut, the second cutting apparatus 100 performs a milling type operation to remove material between the cut sides of the slots with blades 112A, 112B and 112C to create three spaced apart slots 1002. The blades 112 are mounted on an arbor 116 and powered by a motor 118. Hydraulic lines (not shown for clarity) provide drive to the motor 118 from a power takeoff or the engine of the second cutting vehicle 100. The arbor 116 is supported by bearings 122, shown most clearly in FIG. 9. The cutting vehicle 100 also includes depth adjustment devices 124 for setting the maximum depth of the cut made with the cutting assembly 110. As shown in FIG. 10, each of the blades 112 includes teeth 130 extending about the periphery of the blade. The teeth 130 extend radially outward and slightly laterally to opposite alternating sides, thereby achieving an effective cutting width equal to the width of the slot 1002. The teeth 130 are removably mounted for quick and easy interchanging or adjustment from wear and/or breakage.

In operation, after the sides of the slots have been formed with the first cutting vehicle 20 as shown in FIG. 4, the cutting assembly 110 has the depth adjustment devices 124 set so that the blades 112 can penetrate the pavement to the proper depth. The blades 112 are aligned with the associated pairs of opposed side cuts 1012 and lowered to cut away the material between each pair of cut sides 1012. The cutting apparatus 100 generally is driven to extend the cuts in many applications. The teeth 130 of the blades 112 are generally configured for extending slightly laterally so that the proper slot width spanning the cuts 1012 at the sides is achieved for each of the blades 112. The width of the cut is sufficient to extend to remove material between the side cuts 1012 by driving back and forth over the same path as shown in FIG. 3 without moving the cutting vehicle laterally. When the cuts are completed, the three properly spaced apart slots 1002 are formed, as shown in FIG. 1, and are ready for receiving the pavement reinforcement devices 1000.

It can be appreciated that the second cutting vehicle 100 then moves to the next set of cut sides 1012. The slot cutting vehicle 100 removes the need for jackhammers to remove material between sides of the slots 1012. Moreover, the problem of requiring two different sizes of jackhammers to remove the hard to reach bottom material is also eliminated. With the elimination of jackhammers comes the elimination of difficult manual labor and a decrease in costs. Moreover, the cutting vehicle 100 provides a higher quality cut as the blades 130 are set to the proper width and spaced apart so that three spaced apart slots 1002 are formed with proper tolerances and achieve a consistent depth for properly placing the reinforcement systems 1000.

When the slots or recesses 1002 are finished, the reinforcement devices 1000 are placed in the recesses 1002, as shown in FIG. 1. The recesses 1002 are filled in again to provide for repair and reinforcement of the pavement joints 1020 along the road while maintaining a level road surface.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of cutting a slot for a pavement joint, comprising:
providing a first cutting vehicle and a second cutting vehicle;
making simultaneous opposed parallel first cuts into pavement with the first cutting vehicle, wherein the first cuts are spaced apart a first distance and span a pavement joint;
making a second cut intermediate the opposed parallel first cuts into the pavement to remove material remaining between the parallel first cuts with the second cutting vehicle, the second cut having a width equal to the first distance.

2. A method according to claim 1, wherein the first cutting vehicle comprises a cutter assembly having a pair of first rotary blades.

3. A method according to claim 2, wherein the second cutting vehicle comprises a cutter assembly having a second rotary blade.

4. A method according to claim 1, wherein the first cutting vehicle comprises a first cutter assembly having a plurality of pairs of first rotary blades, wherein the pairs of first rotary blades spaced axially apart for cutting a plurality of spaced pairs of parallel first cuts.

5. A method according to claim 4, wherein the second cutting vehicle comprises a second cutter assembly having a plurality of second rotary blades spaced axially apart for cutting a plurality of spaced apart second slot portions.

6. A method according to claim 5, wherein the first and second cutters are driven along the slots while cutting.

7. A method according to claim 5, wherein centerlines of the plurality of blades of the first cutter assembly and centerlines of the plurality of blades of the second cutter assembly are spaced equally apart.

8. A method according to claim 1, further comprising setting a first cutting depth prior to cutting the first slot portion.

9. A method according to claim 8, further comprising setting a second cutting depth prior to cutting the second slot portion.

10. A method according to claim 1, wherein the first and second cutting vehicles are self-propelled.

11. A method according to claim 7, wherein a plurality of first cuts are made simultaneously and a plurality of pairs of second cuts are made simultaneously.

12. A slot cutting apparatus, comprising:
a chassis;
a lift arm assembly pivotally mounted to and extending forward from the chassis, the lift arm assembly moveable between a raised position and a lowered position;
a cutter assembly having a cutter frame attached to the lift arm assembly, the cutter assembly including a plurality of spaced apart rotary cutting blades.

13. A slot cutting apparatus according to claim 12, further comprising a depth adjustment device mounted to the cutter assembly for varying cutting depth.

14. A slot cutting apparatus according to claim 12, further comprising a motor mounted to an arbor, wherein the spaced apart cutting blades are mounted on the arbor.

15. A slot cutting apparatus according to claim 12, wherein the chassis comprises a skid steer loader.

16. A slot cutting apparatus according to claim 12, wherein each of the blades comprises a disk portion and a plurality of teeth spaced about a periphery of the disk portion.

17. A slot cutting apparatus according to claim 16, wherein the teeth are removable.

18. A slot cutting apparatus according to claim 16, wherein the teeth extend substantially radially outward and extend slightly laterally in alternating lateral directions.

19. A slot cutting apparatus according to claim 16, wherein the teeth are interchangeable.

20. An accessory for a skid steer loader, comprising:
a mount for attaching to the loader;
a frame;
an arbor mounted to the frame;
a motor mounted to the arbor;
a plurality of rotary blades mounted to the arbor in a spaced apart relationship; wherein each blade includes a plurality teeth mounted about a periphery of the blade, and wherein the teeth extend substantially radially outward and extend slightly laterally in alternating lateral directions.

21. A pavement slot cutting system, comprising:
a first cutting vehicle having a first cutter assembly having a plurality of pairs of first and second rotary blades, wherein the first and second rotary blades are spaced apart a first distance, wherein centerlines of the pairs of first rotary blades are spaced axially apart a second distance;
a second cutting vehicle having a second cutter assembly with a plurality of second rotary blades having centerlines spaced axially apart the second distance, wherein the second rotary blades have a width equal to the first distance.
